(19) United States
(12) Patent Application Publication
(10) Pub. No.: US 2012/0328458 A1
(43) Pub. Date: Dec. 27, 2012

(54) COMPRESSOR APPARATUS FOR THE TURBOCHARGER OF A PISTON ENGINE AND METHOD FOR OPERATING THE SAME

(75) Inventors: Andreas RAUSCHER, Haibach (DE); Bernhard NOODT, Huenfeld (DE); Christian MUELLER, Ruesselsheim (DE); Michael FINCK, Ruesselsheim (DE)

(73) Assignee: GM GLOBAL TECHNOLOGY OPERATIONS LLC, Detroit, MI (US)

(21) Appl. No.: 13/528,421

(22) Filed: Jun. 20, 2012

(30) Foreign Application Priority Data
Jun. 21, 2011 (DE) 10 2011 105 917.6

(51) Int. Cl. F02B 37/00; F04D 27/00; F04D 29/00

(52) U.S. Cl. 417/406; 415/52.1; 415/1

(57) ABSTRACT

A compressor apparatus for the turbocharger of a piston engine is provided. The compressor apparatus includes a compressor for compressing a flowing medium to produce a compressed medium and a return device by which at least a partial stream of the compressed medium is fed anew to the compressor.

### CROSS-REFERENCE TO RELATED APPLICATION

This application claims priority to German Patent Application No. 10 2011 105 917.6, filed Jun. 21, 2011, which is incorporated herein by reference in its entirety.

### TECHNICAL FIELD

The technical field relates to a compressor apparatus for the turbocharger of a piston engine, in particular for use in a motor vehicle, as well as a method for operating the compressor apparatus. The technical field further relates to a turbocharger for a piston engine.

### BACKGROUND

Compressor apparatuses of the type discussed here are usually part of a turbocharger for a piston engine and are used to compress the air taken in by the piston engine, whereby an increase in the power of the piston engine is obtained. Such turbochargers are frequently used in motor vehicles today in order to increase the power of the internal combustion engine.

The design of the compressor apparatus is usually aimed at the piston engine having the highest possible torque at low rotational speeds. However, the design of the compressor apparatus is made difficult by the natural limit of the compressor, the so-called surge limit. In the area of the surge limit or when exceeding the surge limit, unstable flow behavior as far as separation of the flow occurs and associated with this is a loss of performance of the compressor apparatus. The unstable flow behavior of the compressor apparatus is also noticeable in the disturbing charge exchange noise, so-called hissing or surging.

It has been shown that the design of the compressor apparatuses in modern piston engines is frequently near the limiting range of the compressor, so that depending on the actually existing operating point of the compressor apparatus, the surge limit may be exceeded with the associated consequences.

It is therefore at least one object herein to provide a compressor apparatus for a turbocharger of a piston engine, in particular for use in a motor vehicle, having the features specified initially, which reliably prevents the surge limit of the compressor of the compressor apparatus being exceeded and the associated charge exchange noise as well as flow separation. A corresponding method for operating a compressor apparatus for a turbocharger is further to be provided. A turbocharger for a piston engine, in particular an exhaust gas turbocharger, is also to be proposed, which is suitable for the use of such a compressor apparatus. In addition, other objects, desirable features and characteristics will become apparent from the subsequent summary and detailed description, and the appended claims, taken in conjunction with the accompanying drawings and this background.

### SUMMARY

A compressor apparatus for the turbocharger of a piston engine, in particular for use in a motor vehicle, has a compressor for compressing a flowing medium, in particular air.

According to an embodiment, the compressor apparatus has a return device, by which means at least a partial stream of the compressed medium can be fed or is fed anew to the compressor.

The renewed supply of already-compressed medium increases the flow of medium through the compressor and thus increases the distance of the operating range of the compressor from the surge limit. If the operating range or at least one operating point of the compressor is located in the unstable flow range, by means of the measure according to an embodiment the operating range or operating point is shifted from the unstable range into the stable-flow operating range. By means of the compressor apparatus, it can thus be effectively avoided or is effectively avoided that the compressor reaches or exceeds the surge limit. Any unstable behavior of the flow of the medium passed through the compressor is thereby also avoided such as any noise, such as for example, charge exchange noise. The renewed supply of already compressed medium also results in an increased efficiency of the compressor.

As a result of the measure, a high torque can already be achieved particularly effectively at low rotational speeds and at the same time a particularly effective increase in power of the piston engine can be achieved at full load or nominal load without the surge limit being thereby reached or exceeded with the associated flow instabilities and charge exchange noise.

The compressor apparatus is therefore particularly suitable for use in a turbocharger of a diesel engine, in particular when this comprises a highly supercharged diesel engine.

According to an embodiment, it is provided that a cooling device is connected downstream of the return device for cooling the compressed medium, so that by means of the return device at least a partial stream of the compressed and cooled medium can be fed or is fed anew to the compressor. An additional thermal loading of the compressor by the compressed medium supplied anew is thereby avoided. This measure also has the aim of avoiding a reduction in the efficiency of the compressor by means of a high temperature of the compressed medium supplied to the compressor.

According to a further embodiment, an adjusting device operatively connected to the return device is provided, by which means the stream of compressed medium to be returned may be adjusted or is adjusted. By this measure, the stream of compressed medium to be returned may be regulated in a simple manner, preferably may be regulated or adjusted continuously, so that depending on the instantaneous operating point of the compressor or the compressor apparatus, the partial stream of already compressed medium supplied to the compressor can be specifically metered so that the instantaneous operating point of the compressor lies near the surge limit but the does not reach or exceed the surge limit itself The respective instantaneous operating point of the compressor is thus to be shifted in such a manner that the compressor delivers the best possible efficiency in each case and flow instabilities associated with perturbing flow noise are avoided.

It is possible that the adjusting device is substantially continuously adjustable. As a result, the compressor can be optimized in a particularly efficiency-optimized manner.

It is further possible that the adjusting device can be actuated electrically. For example, the adjusting device can be actuated or is actuated by electric motor or electromagnetically. As a result of the electrical actuation of the adjusting device, the adjusting device can be incorporated technically particularly easily in an electronic regulation or control system for adjusting the stream of compressed medium to be returned.

Naturally it is also feasible that the adjusting device can be actuated pneumatically or hydraulically.

The adjusting device can comprise a piston element or flap element by which means the flow of the stream of compressed medium to be returned may be adjusted or is adjusted. It is thereby possible to regulate the flow of compressed medium to be returned in a technically simple and cost-effective manner. The piston element and the flap element also enable a fine metering of the flow of returned compressed medium.

In order to be able to automatically adjust or regulate the flow of the stream of compressed medium to be returned, it is possible that the adjusting device may be coupled or is coupled as a control element to a control or regulating device. When regulating or controlling the stream of compressed medium to be returned, use is preferably made of measured values such as, for example, the flow through the compressor and/or the pressure of the medium upstream of the compressor and/or downstream of the compressor.

According to one embodiment, at least one flow sensor upstream of the compressor is therefore provided by which the stream of medium flowing into the compressor can be determined and can preferably be used as at least one electrical signal.

The flow sensor is preferably disposed in such a manner that the stream of medium flowing into the compressor is detected, which is supplied to the compressor for the first time, that is, without the returned partial stream of already compressed medium. The flow sensor is preferably disposed upstream of the compressor to such an extent that the flow sensor is also mounted upstream of the feed point of compressed partial stream.

The flow sensor can be configured as a mass flow sensor or volume flow sensor so that the stream of compressed medium to be returned can be tapped by an electrical signal at the flow sensor corresponding to the mass flow or the volume flow.

According to a further embodiment, a pressure sensor downstream of the compressor is provided, by which means the pressure of the compressed medium can be determined as absolute pressure or difference pressure and can preferably be used as at least one electrical signal. The pressure sensor can be configured as an absolute pressure gauge in which the atmospheric pressure is contained in the detected measured value. In one embodiment of the pressure sensor as a reference pressure sensor, the measured pressure is detected as a difference pressure compared with a reference pressure so that the determined pressure is independent of the atmospheric pressure.

The pressure sensor is preferably located downstream of the cooling device for cooling the compressed medium and downstream of the return device so that by means of the pressure sensor the pressure of the compressed medium in the cooled state at the outlet of the compressor apparatus is present as the absolute pressure or difference pressure and can be used as an electrical signal.

According to a further embodiment, a method for operating a compressor apparatus for the turbocharger of a piston engine, in particular for use in a motor vehicle, is provided. The compressor apparatus has a compressor for compressing a flowing medium. The compressor apparatus can be a compressor apparatus of the type described hereinbefore.

According to the method, a partial stream of the compressed medium is fed anew to the compressor. As a result of this return of the compressed medium to the compressor, the flow of medium entering into the compressor and therefore the throughput through the compressor is increased, which consequently results in an increase in the efficiency of the compressor. Also the instantaneous operating point of the compressor is thereby shifted away from the surge limit of the compressor, so that flow instabilities and an associated noise formation due to charge exchange are avoided.

It is possible that when the piston engine is under partial load or full load, a partial stream of the compressed medium is fed anew to the compressor. By this means the piston engine is substantially optimally supercharged over its entire load range, that is supplied with compressed medium, without the compressor of the compressor apparatus itself thereby entering into a critical operating state, i.e. reaching or exceeding the surge limit. The piston engine can itself be optimally supercharged at high torque and low rotational speeds without the compressor reaching or exceeding the surge limit and thereby resulting in flow instabilities in the compressor and undesirable noise formation due to charge exchange.

It is further possible that the compressed medium is initially cooled and then a partial stream of the compressed and cooled medium is fed anew to the compressor. As a result of the already compressed medium being previously cooled and a partial stream only then being returned back to the compressor, heating of the media stream passed through the compressor is counteracted. Thermal loading states in the compressor can thereby be avoided. Also due to the low temperature of the medium passed through the compressor, the compressor itself can be operated at a higher efficiency.

According to a further embodiment, it is provided that the partial stream fed to the compressor is adjusted. As a result, the partial stream of already compressed medium fed to the compressor is adjusted individually to the instantaneous operating point of the compressor present in each case and optimized so that the instantaneous operating point of the compressor lies near the optimum, without thereby reaching or exceeding the surge limit.

The partial stream supplied to the compressor is preferably regulated taking into account the flow of medium into the compressor and/or the pressure of the medium after the compressor.

According to another embodiment, the flow of medium flowing into the compressor and the pressure, in particular the absolute pressure, of the compressed medium are detected as instantaneous values, and preferably from this, instantaneous values are determined for the pressure ratio of the compressor. Preferably the instantaneous values for the pressure ratio are then each compared against a predefined set-point value. Such a procedure is technically easy to implement.

According to a further embodiment, the flow of medium flowing into the compressor and the pressure, in particular the absolute pressure, of the compressed medium are detected as instantaneous values, from this, instantaneous values are preferably determined for the difference between a predefined critical pressure ratio, for example, the pressure ratio at the surge limit of the compressor, and the instantaneous pressure ratio of the compressor, which are preferably then each compared against a predefined set-point value. By this means, the critical pressure ratio, in particular the pressure ratio at the surge limit of the compressor, is directly taken into account. In the event of a change in the type of vehicle and/or the turbocharger type, then merely the critical pressure ratio needs to be changed accordingly without needing to make any complex new data input of any stored characteristics for this purpose.

It is possible that the setpoint value is predefined as a function of the mass flow or volume flow of the compressor. Since the individual values for the mass flow or volume flow of the compressor are each assigned at least one setpoint value, a corresponding setpoint value can be assigned individually in each case over the entire operating range of the compressor.

The critical pressure ratio of the compressor, for example, the critical pressure ratio at the surge limit of the compressor can be predefined as the setpoint value.

The difference between a predefined critical pressure ratio and a safety factor can also be taken as setpoint value so that the respective setpoints relate to an operating point which has a safety margin from the critical pressure ratio, for example, at the surge limit of the compressor, as a function of the mass flow or volume flow of the medium passed through the compressor.

The instantaneous pressure ratio of the compressor can be calculated by a processing unit. The processing unit can be the controller of the piston engine, the so-called ECU. All the other calculation processes in the course of the process can also be performed by the processing unit, in particular the controller of the piston engine.

The measured values of the mass flow or volume flow for the medium are preferably processed in a temperature-corrected manner for this purpose, i.e. in a temperature-standardized manner. In addition, allowance for the air pressure can be made by processing the values normalized to compressed air in relation to atmospheric pressure. To this end, use is preferably made of measured values of the atmospheric pressure for which at least one corresponding sensor is provided.

The setpoint values can be stored as a function of the volume flow or mass flow of the compressor as a characteristic in a storage unit of a control and/or regulating device or control device.

It is possible that on exceeding the setpoint value, the returned partial stream of compressed medium is increased. It is thereby ensured that the instantaneous operating point of the compressor present in each case is shifted by the partial stream of already-compressed medium into the compressor away from the setpoint value in the direction of the non-critical operating range.

A control and/or regulating device for a compressor apparatus of the type described hereinbefore is further provided.

The control and/or regulating device preferably executes the steps of a method of the type described hereinbefore.

A computer program which executes the steps of a method of the type described hereinbefore when it is executed is also provided.

A data carrier which has a computer program of the preceding type is further provided.

According to a further embodiment, a turbocharger for a piston engine, in particular an exhaust gas turbocharger, comprising a compressor apparatus of the type described hereinbefore, which is operated in particular by means of a method of the type described hereinbefore, is provided.

It is possible that the turbocharger comprises a turbine driving the compressor apparatus which has adjustable blade elements. To this end, the turbine can have a variable turbine geometry, for example a so-called VTG turbine. By this means the power output and the response behavior of the turbocharger to different operating conditions such as a change in the load of the piston engine can be better adapted. In order to achieve this, adjustable, non-rotating guide vanes can be located in the turbine inlet or in the turbine housing. The angle of inclination of the guide vanes can be adjusted so that when there is little throughput through the turbine but a high power requirement of the turbocharger, the exhaust gas is accelerated by reduced flow cross-sections and guided to the turbine blades, which increases the rotational speed of the turbine and therefore the power of the compressor.

Due to the variability of the turbine, it is possible that the compressor of the turbocharger driven by the turbine varies its rotational speed according to the rotational speed of the turbine and therefore a power matching of the compressor to the operating conditions prevailing in each case is achieved in a simple manner.

A motor vehicle having a piston engine and a turbocharger cooperating with the piston engine, in particular an exhaust gas turbocharger, of the type described hereinbefore is provided.

The turbocharger preferably comprises a compressor apparatus of the type described hereinbefore, which is preferably operated by a method of the type described hereinbefore.

The piston engine is preferably a diesel engine which is supercharged by means of the turbocharger.

### BRIEF DESCRIPTION OF THE DRAWINGS

The various embodiments will hereinafter be described in conjunction with the following drawing figures, wherein like numerals denote like elements, and wherein:

FIG. 1 is a schematic view of an exhaust gas turbocharger cooperating with a piston engine in accordance with an exemplary embodiment; and

FIG. 2 shows the characteristic of a compressor for the exhaust gas turbocharger according to FIG. 1 in a diagrammatic view with optimized full-load characteristic plotted therein.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

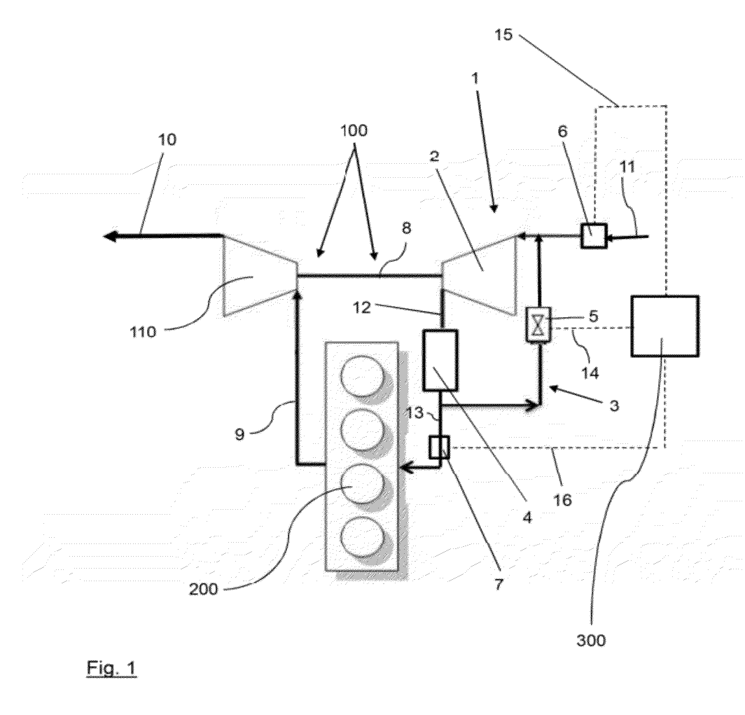

FIG. 1 shows—in schematic view—a piston engine 200, in particular a diesel engine, which cooperates with an exhaust gas turbocharger 100. The exhaust gas turbocharger comprises a turbine 110 which can be driven by exhaust gas of the piston engine 200 and a compressor apparatus 1.

For driving the turbine 110, the exhaust gas of the piston engine 200 is fed according to arrow 9 to the turbine 110, where the turbine 110 is driven using the energy of the exhaust gas. The exhaust gas then leaves the turbine 110 according to arrow 10 and preferably is removed by means of an exhaust system (not shown in FIG. 1).

The turbine 110 is mechanically connected to a compressor 2 of the compressor apparatus 1. Preferably the turbine 110 drives the compressor 2 via a shaft 8.

The compressor 2 driven by the turbine 110 sucks in a flowing medium, in particular external air or ambient air according to arrow 11, compresses the air, and delivers the compressed air via an outlet line 12. The compressed air is preferably fed to a cooling device 4, which is located downstream of the compressor 2 and is used to cool the compressed air. The compressed air and preferably cooled air is then supplied according to arrow 13 to the piston engine 200 as combustion air or is taken in by the piston of the piston engine 200.

According to an embodiment, the compressor apparatus 1 comprises a return device 3 through which a partial stream of the compressed medium is fed anew to the compressor 2.

The return device 3 is preferably disposed in such a manner that a partial stream of the compressed medium is only removed after the cooling device 4 so that the compressed medium is fed anew to the compressor 2 as a partial stream in already cooled form.

The compressor apparatus 1 preferably comprises at least one pipeline which, for example, opens into a branch of an output line of the cooling device 4 and furthermore is fluidically connected to an inlet line or to an inlet region for the compressor 2.

The return device 3 furthermore comprises an adjusting device 5, by which means the returned partial stream of compressed medium can be regulated. The adjusting device 5 is preferably integrated in the return line of the return device 3 and can comprise a valve, in particular a piston valve, in order to thereby regulate or adjust the flow of the partial stream through the return line.

The adjusting device 5 further preferably comprises an electrical drive or an electromagnetic drive in order to be able to regulate the flow by electrically triggering the drive for the valve.

The adjusting device 5 is operatively connected via at least one signal line 14 to a control or regulating device 300, through which the adjusting device 5 is controlled and/or regulated, that is, the partial stream of compressed air returned to the compressor 2 is adjusted. The control or regulating device 300 can be partially or completely integrated in the controller for the piston engine 200.

The control/regulating device 300 controls or regulates the flow of returned partial stream taking into account the volume flow or mass flow of medium flowing into the compressor 2, in particular external air or ambient air, and the pressure of the supercharged air, which is fed to the piston engine 200. To this end, preferably at least one flow sensor 6 located upstream of the compressor 2 is provided, which is preferably also located upstream of the access for the partial stream of returned compressed air so that the flow sensor 6 merely detects the flow of non-returned medium, which enters into the compressor 2. The flow sensor 6 is preferably formed by an air mass meter.

Furthermore, a pressure sensor 7 located downstream of the compressor 2 is provided. The pressure sensor 7 is preferably located downstream of the cooling device 4 so that the pressure of the compressed and cooled air is detected by the pressure sensor 7, where the pressure sensor 7 is preferably disposed after the removal point for the returned partial stream of compressed air. The pressure sensor 7 is preferably an absolute pressure sensor.

The pressure sensor 7 and the flow sensor 6 are each configured to produce electrical signals correlating with the measured values, which are transmitted via signal lines 15, 16 to the control or regulating device 300.

The following procedure can be carried out to regulate the returned partial stream of compressed air to the compressor 2:

The air stream flowing into the compressor 2 is detected by means of the flow sensor 6 and the pressure of the compressed air through the pressure sensor 7. The flow sensor 6 and the pressure sensor 7 preferably deliver instantaneous values via the signal lines 15 and 16 to the control or regulating device 300. A respective instantaneous value for the pressure ratio of the compressor is determined from the respective instantaneous value of the compressed air and optionally from the respective instantaneous value of the air stream flowing into the compressor 2, and in particular is calculated by means of a calculation formula in the control or regulating device 300. Then the respective instantaneous value is compared against a predefined setpoint value.

The setpoint value is stored as a function of the throughput, in particular mass flow or volume flow of the compressor 2, in the control or regulating device 300 in a memory unit. The characteristic for the compressor 2 is preferably stored in the memory unit, where the setpoint values as a function of the mass flow or volume flow of the air through the compressor 2 relate to the surge limit of the compressor 2 or the profile of the surge limit of the compressor 2.

It can also be the case that a difference between a predefined critical pressure ratio, preferably the critical pressure ratio of the compressor 2 at the surge limit and a predefined safety factor are predefined and stored as predefined setpoint values. In this case, the control or regulating device 300 calculates from the values delivered by the flow sensor 6 and the pressure sensor 7 a difference between the predefined critical pressure ratio and the instantaneous pressure ratio of the compressor 2 and in each case compares this difference with the predefined setpoint value.

If the control or regulating device 300 determines that the predefined setpoint value is exceeded, the partial stream of compressed air returned to the compressor 2 is increased. The partial stream of compressed air is preferably increased by a predefined value. To this end, the adjusting device 5 is adjusted by means of a predefined value.

If at least one successive determined instantaneous value still exceeds the setpoint value, the returned partial stream of compressed air is increased once again by the adjusting device 5. This takes place until the determined instantaneous values lie below the predefined setpoint value.

The control or regulating device 300 can be designed in such a manner that the partial stream of returned compressed air is reduced if the at least one determined instantaneous value falls below a predefined minimum value. It is thereby ensured that by regulating the partial stream of returned compressed air, the compressor 2 operates with the highest possible efficiency and outside the critical range of the compressor 2, i.e. below the surge limit depending on the operating state of the piston motor 200.

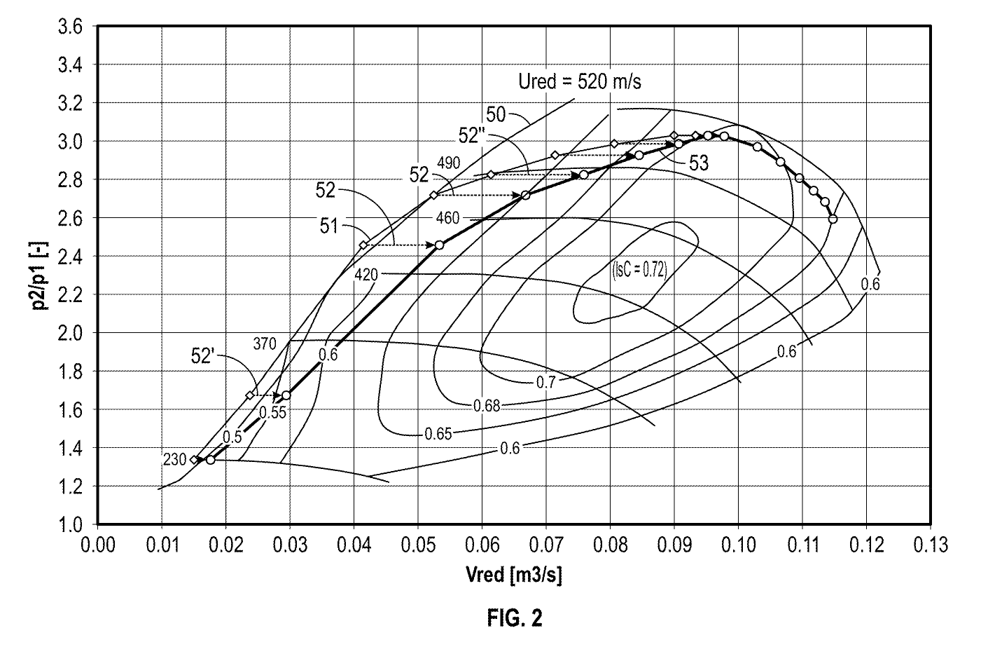

FIG. 2 shows the possible operating mode of the method by means of the return device 3 by reference to the characteristic of the compressor 2 shown there. The volume flow is plotted as a characteristic value on the abscissa and the pressure ratio, given as the ratio of the final pressure to the suction pressure of the compressor 2, is plotted as a characteristic value on the ordinate. The characteristic curve 50 which can be seen therein shows the surge limit of the compressor 2. The characteristic curve identified by the reference number 51 in FIG. 2 shows the behavior of the pressure ratio of the compressor 2 as a function of this volume flow when the piston engine 200 is at full load.

As can be seen in FIG. 2, the characteristic curve 51 runs above the surge limit (characteristic curve 50) over several sections, and has therefore already exceeded the surge limit of the compressor 2. In this range, flow separation occurs and associated with this an undesired noise formation accompanying charge exchange.

As a result of the return of a partial stream of compressed air to the compressor 2 and the recirculation of the air already compressed once thereby made, a shift of the characteristic curve 51 in the direction of the arrow 52 is possible so that the characteristic curve which has been corrected or optimized by the return or return device 3 is located completely within the stable working range of the compressor 2, as can be seen by reference to the characteristic curve having the reference number 53.

FIG. 2 further shows that by regulating the returned partial stream of compressed air by means of the adjusting device 5, the shift in direction according to arrow 52 can be different according to the operating point. For example, the shift according to arrow 52′ is smaller than the shift according to arrow 52″, which is caused by a different flow adjustment by the adjusting device 5.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A compressor apparatus for a turbocharger of a piston engine, the compressor apparatus comprising:
a compressor for compressing a flowing medium to produce a compressed medium; and
a return device configured for feeding anew an at least partial stream of the compressed medium to the compressor.

2. The compressor apparatus according to claim 1 wherein the piston engine is for use in a motor vehicle.

3. The compressor apparatus according to claim 1 wherein the flowing medium is air.

4. The compressor apparatus according to claim 1, wherein a cooling device is connected downstream of the return device for cooling the compressed medium to produce a compressed and cooled medium so that by the return device the at least partial stream of the compressed and cooled medium can be fed anew to the compressor.

5. The compressor apparatus according to claim 1, wherein an adjusting device is operatively connected to the return device and is configured to adjust the at least partial stream of the compressed medium.

6. A method for operating a compressor apparatus for a turbocharger of a piston engine, the method comprising the steps of:
compressing a flowing medium using a compressor of the compressor apparatus to produce a compressed medium;
feeding anew a partial stream of the compressed medium to the compressor.

7. The method according to claim 6, wherein compressing comprises compressing the flowing medium using the compressor of the compressor apparatus for the turbocharger of the piston engine of a motor vehicle.

8. The method according to claim 6, wherein feeding comprises feeding anew the partial stream of the compressed medium to the compressor when the piston engine is under partial load or full load.

9. The method according to claim 6, further comprising cooling the compressed medium to produce a compressed and cooled medium and wherein feeding comprises feeding anew a partial stream of the compressed and cooled medium to the compressor.

10. The method according to claim 6, wherein feeding comprises adjusting a flow of the partial stream fed to the compressor based on a volume flow or a mass flow of the compressed medium in the compressor and/or a pressure of the compressed medium after the compressor.

11. The method according to claim 6, wherein a flow of the compressed medium flowing into the compressor and a pressure of the compressed medium are detected as instantaneous values, from the instantaneous values a pressure ratio of the compressor is determined, and the instantaneous values are each compared against a respective predefined set-point value.

12. The method according to claim 11, wherein the pressure of the compressed medium is measured as an absolute pressure.

13. The method according to claim 11, wherein the respective predefined setpoint value is predefined as a function of a mass flow or volume flow of the compressor.

14. The method according to claim 11, further comprising increasing the partial stream of the compressed medium fed to the compressor upon exceeding the predefined set-point value.

15. The method according to claim 6, wherein a flow of the compressed medium flowing into the compressor and a pressure of the compressed medium are detected as instantaneous values, from the instantaneous values an instantaneous pressure ratio of the compressor is determined, a difference between a predefined critical pressure ratio and the instantaneous pressure ratio of the compressor is determined, and the difference is then compared against a predefined set-point value.

16. The method according to claim 15, wherein the respective predefined setpoint value is predefined as a function of a mass flow or volume flow of the compressor.

17. A control and/or regulating device for a compressor apparatus of a turbocharger, wherein the control and/or regulating device embodies a computer program configured to execute a method comprising the steps of:
compressing a flowing medium using a compressor of the compressor apparatus to produce a compressed medium;
feeding anew a partial stream of the compressed medium to the compressor.

18. Turbocharger for a piston engine comprising a compressor apparatus comprising:
a compressor for compressing a flowing medium to produce a compressed medium; and
a return device by which at least a partial stream of the compressed medium is fed anew to the compressor.

19. The turbocharger according to claim 18, wherein the turbocharger is an exhaust gas turbocharger.

20. The turbocharger according to claim 18, wherein the turbocharger comprises a turbine driving the compressor apparatus having adjustable blade elements.
